(19) United States
(12) Patent Application Publication
(10) Pub. No.: US 2025/0364584 A1
(43) Pub. Date: Nov. 27, 2025

(54) ELECTROLYTE COMPOSITION FOR INHIBITING THERMAL RUNAWAY OF BATTERY CELLS

(71) Applicant: GM Global Technology Operations LLC, Detroit, MI (US)

(72) Inventors: Yan Wu, Shanghai (CN); Dewen Kong, Shanghai (CN); Jingyuan Liu, Shanghai (CN); Si Chen, Shanghai (CN); Haijing Liu, Shanghai (CN)

(21) Appl. No.: 18/737,294

(22) Filed: Jun. 7, 2024

(30) Foreign Application Priority Data
May 22, 2024 (CN) 202410641962.9

(51) Int. Cl. H01M 10/0525; H01M 10/0567; H01M 10/0568; H01M 10/0569

(52) U.S. Cl. CPC H01M 10/0525; H01M 10/0567; H01M 10/0568; H01M 10/0569; H01M 2300/0034; H01M 2300/004

(57) ABSTRACT

Systems, methods, and compositions for an electrolyte that inhibits thermal runaway are disclosed. For example, an electrochemical cell may include an anode, a cathode, and the electrolyte. The anode includes a lithiated silicon oxide material, the cathode includes a nickel-rich material, and the electrolyte is formed from an electrolyte mixture. The electrolyte mixture includes a primary salt, a secondary salt, and a solvent. The primary salt is configured to facilitate ion movement between the anode and the cathode. The secondary salt is a high-HOMO salt. The secondary salt is also configured to form a solid-electrolyte interphase on the anode and a cathode-electrolyte interphase on the cathode. The solvent includes a cyclic solvent component, a linear solvent component, and a fluorinated solvent component.

### INTRODUCTION

The disclosure relates to the field of electrolyte compositions and, more specifically, to inhibiting thermal runaway in lithium-ion batteries.

Lithium-ion batteries (LiBs) are used for various secondary-battery applications. This is particularly due to the high energy density and rechargeability of the LiBs. However, the high energy density and chemistry of LiBs may result in battery cells experiencing thermal runaway events and combustion if the cell is damaged, shorted, or exposed to excessive temperatures. Therefore, there is a need in the art to mitigate and/or inhibit occurrence of thermal runaway events.

### SUMMARY

Lithium-ion batteries using nickel-rich cathode∥Li_{y}SiOₓ (LSO) cells may experience thermal runaway in response to the temperature of the battery cell exceeding a certain temperature. More particularly, nickel-rich cathodes with a layered structure at a charged state may experience a structural collapse at a temperature of approximately 210° C. This collapse generates oxygen radicals, which intensely react with carbonates in the electrolyte. The heat produced by these reactions rapidly drive the temperature of the cell higher. When the battery cell temperature exceed 300° C., further exothermal reactions are triggered by the LSO, which may result in combustion of the battery.

Beneficially, electrolytes in accordance with the present disclosure may be used to mitigate and/or inhibit occurrence of thermal runaway events. These electrolytes may inhibit occurrence of thermal runaway events or mitigate the extent of thermal runaway while providing performance characteristics comparable to or in excess of the performance characteristics of, for example, an electrolyte of LiPF₆, ethylene carbonate, and ethyl methyl carbonate.

According to aspects of the present disclosure, an electrochemical cell includes an anode, a cathode, and an electrolyte. The anode includes a lithiated silicon oxide material, the cathode includes a nickel-rich material, and the electrolyte is formed from an electrolyte mixture. The electrolyte mixture includes a primary salt, a secondary salt, and a solvent. The primary salt is configured to facilitate ion movement between the anode and the cathode. The secondary salt is a high-HOMO salt. The secondary salt is also configured to form a solid-electrolyte interphase on the anode and a cathode-electrolyte interphase on the cathode. The solvent includes a cyclic solvent component, a linear solvent component, and a fluorinated solvent component.

According to further aspects of the present disclosure, the mixture further includes an additive configured to enhance a solid-electrolyte interface of the anode, the additive being selected from the group consisting of succinic anhydride; vinylene carbonate; tri-methoxymethylsilane; 1,3,2-dioxathiolane-2,2-dioxide; tris(trimethylsilyl) phosphite; and combinations thereof.

According to further aspects of the present disclosure, the high-HOMO salt is selected from the group consisting essentially of lithium difluoro(oxalato)borate (LiDFOB); lithium bis(oxalato)borate (LiBOB); lithium nitrite (LiNO₃); lithium difluorophosphate (LiDFP); lithium carbonate (Li₂CO₃); lithium fluoromalonato(difluoro)borate (LiFMDFB); lithium hexamethyldisilazide (LiHMDS); lithium tetrakis(pentafluorophenyl)borate (LiTPFPB); and combinations thereof.

According to further aspects of the present disclosure, the high-HOMO salt is present in a concentration between 0.05M and 0.5M.

According to further aspects of the present disclosure, the fluorinated solvent component is configured to inhibit side-reactions and consumption of the electrolyte and is selected from the group consisting of fluoroethylene carbonate (FEC); difluoroethylene carbonate (DFEC); trifluoropropylene carbonate (TFPC); 4-((2,2,3,3-tetrafluoro-propoxy)methyl)-1,3-dioxolan-2-one (HFEEC); 4-(2,2,3,3,4,4,5,5,5-nonafluoropentyl)-1,3-dioxolan-2-one (NFPEC) di (2,2,2 trifluoroethyl) carbonate (DFDEC); methyl (2,2,2 trifluoroethyl) carbonate (FEMC); methyl nonafluorobutyl ether (MFE); 1,1,1,3,3,3 hexafluoroisopropyl methyl ether (HFPM); 1,1,2,2 tetrafluoroethyl 2,2,3,3 tetrafluoropropyl ether (F EPE); propargyl 2,2,2 trifluoroethyl carbonate; 2 cyanoethyl (2,2,2 trifluoroethyl) carbonate; 2,2,2 trifluoroethyl allyl carbonate; 3,5,8,10 oxa 4,9 carbonyl 1,1,1,12,12,12 hexafluoro-dodecane; 3,5,9,11 oxa 4,10 carbonyl 1,1,1,13,13,13 hexafluorotridecane; 3,5,10,12 oxa 4,11 carbonyl 1,1,1,14,14,14 hexafluorotetradecane; 3,5,10,12 oxa 4,11 carbonyl 1,1,1,14,14,14 hexafluoro 7 tetradecane; and combinations thereof.

According to further aspects of the present disclosure, the cyclic solvent component includes fluorine and has the following structure:

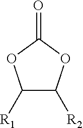

the linear solvent component includes fluorine and has the following structure:

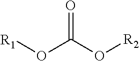

and each of the R-groups is selected from the group consisting of hydrogen, fluorine, a linear alkyl moiety, a branched alkyl moiety, a linear alkene moiety, a branched alkene moiety, a fluorinated alkyl moiety, and a fluorinated alkene moiety.

According to further aspects of the present disclosure, the primary salt is LiPF6 present in a concentration of 0.5M, the secondary salt is LiDFOB present in a concentration of 0.5M, the cyclic solvent component is a combination of EC and PC, the linear solvent component is DEC, and the fluorinated solvent component is a combination of FEC and DFDEC.

According to further aspects of the present disclosure, the FEC is present in an amount of 15 wt % on the basis of the electrolyte.

According to further aspects of the present disclosure, the electrochemical cell further includes vinylene carbonate (VC) in an amount of 1 wt % on the basis of the electrolyte.

According to further aspects of the present disclosure, the electrochemical cell is formed by hot laminating the anode, the cathode, and a separator using a temperature between 65° C. and 85° C.

According to aspects of the present disclosure, an electrolyte includes a primary salt, a secondary salt, and a solvent. The primary salt is configured to facilitate ion movement between an anode and a cathode. The secondary salt is a high-HOMO salt. The secondary salt is also configured to form a solid-electrolyte interphase on the anode and a cathode-electrolyte interphase on the cathode. The solvent includes a cyclic solvent component, a linear solvent component, and a fluorinated solvent component.

According to further aspects of the present disclosure, the electrolyte further includes an additive configured to enhance a solid-electrolyte interface of the anode, the additive being selected from the group consisting of succinic anhydride; vinylene carbonate; tri-methoxymethylsilane; 1,3,2-dioxathiolane-2,2-dioxide; tris(trimethylsilyl) phosphite; and combinations thereof.

According to further aspects of the present disclosure, the high-HOMO salt is selected from the group consisting essentially of lithium difluoro(oxalato)borate (LiDFOB); lithium bis(oxalato)borate (LiBOB); lithium nitrite (LiNO₃); lithium difluorophosphate (LiDFP); lithium carbonate (Li₂CO₃); lithium fluoromalonato(difluoro)borate (LiFMDFB); lithium hexamethyldisilazide (LiHMDS); lithium tetrakis(pentafluorophenyl)borate (LiTPFPB); and combinations thereof.

According to further aspects of the present disclosure, the high-HOMO salt is present in a concentration between 0.05M and 0.5M.

According to further aspects of the present disclosure, the fluorinated solvent component is configured to inhibit side-reactions and consumption of the electrolyte and is selected from the group consisting of fluoroethylene carbonate (FEC); difluoroethylene carbonate (DFEC); trifluoropropylene carbonate (TFPC); 4-((2,2,3,3-tetrafluoro-propoxy)methyl)-1,3-dioxolan-2-one (HFEEC); 4-(2,2,3,3,4,4,5,5,5-nonafluoropentyl)-1,3-dioxolan-2-one (NFPEC) di (2,2,2 trifluoroethyl) carbonate (DFDEC); methyl (2,2,2 trifluoroethyl) carbonate (FEMC); methyl nonafluorobutyl ether (MFE); 1,1,1,3,3,3 hexafluoroisopropyl methyl ether (HFPM); 1,1,2,2 tetrafluoroethyl 2,2,3,3 tetrafluoropropyl ether (F EPE); propargyl 2,2,2 trifluoroethyl carbonate; 2 cyanoethyl (2,2,2 trifluoroethyl) carbonate; 2,2,2 trifluoroethyl allyl carbonate; 3,5,8,10 oxa 4,9 carbonyl 1,1,1,12,12,12 hexafluoro-dodecane; 3,5,9,11 oxa 4,10 carbonyl 1,1,1,13,13,13 hexafluorotridecane; 3,5,10,12 oxa 4,11 carbonyl 1,1,1,14,14,14 hexafluorotetradecane; 3,5,10,12 oxa 4,11 carbonyl 1,1,1,14,14,14 hexafluoro 7 tetradecane; and combinations thereof.

According to further aspects of the present disclosure, the cyclic solvent component includes fluorine and has the following structure:

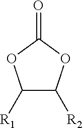

the linear solvent component includes fluorine and has the following structure:

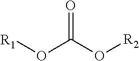

and each of the R-groups is selected from the group consisting of hydrogen, fluorine, a linear alkyl moiety, a branched alkyl moiety, a linear alkene moiety, a branched alkene moiety, a fluorinated alkyl moiety, and a fluorinated alkene moiety.

According to further aspects of the present disclosure, the primary salt is LiPF6 present in a concentration of 0.5M, the secondary salt is LiDFOB present in a concentration of 0.5M, the cyclic solvent component is a combination of EC and PC, the linear solvent component is DEC, and the fluorinated solvent component is a combination of FEC and DFDEC.

According to further aspects of the present disclosure, the FEC is present in an amount of 15 wt % on the basis of the electrolyte.

According to further aspects of the present disclosure, the electrolyte further includes vinylene carbonate (VC) in an amount of 1 wt % on the basis of the electrolyte.

According to further aspects of the present disclosure, the electrolyte is configured to be incorporated into an electrochemical cell formed by hot laminating the anode, the cathode, and a separator using a temperature between 65° C. and 85° C.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 illustrates a schematic battery cell including an electrolyte, according to aspects of the present disclosure;

FIG. 2 illustrates a chart of specific capacity for the formation cycle of an example coin cell;

FIG. 3 illustrates a chart of capacity retention over charge-discharge cycles for example and comparator full coin cells;

FIG. 4 illustrates a chart showing results of low-temperature discharge test;

FIG. 5 illustrates a chart showing results of differential scanning calorimetry test on an example and a comparator electrolyte; and

FIG. 6 illustrates a chart showing results a thermal ramping test for an example and a comparator pouch cell.

### DETAILED DESCRIPTION

The following detailed description is merely exemplary in nature and is not intended to limit the application and uses. Furthermore, there is no intention to be bound by expressed or implied theory presented in the preceding introduction, summary, or brief description of the drawings or the following detailed description.

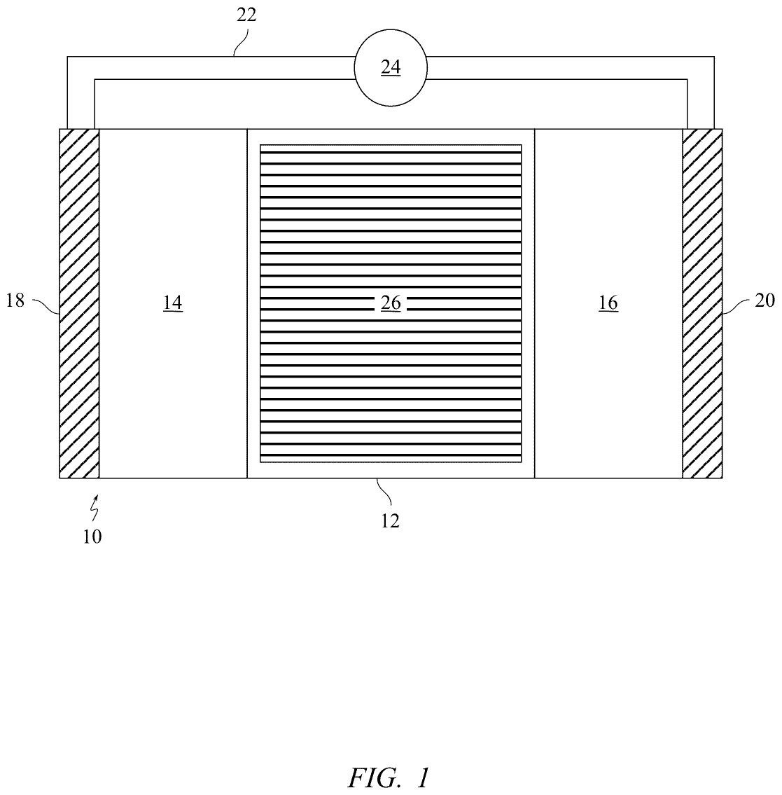

FIG. 1 illustrates a schematic battery cell 10 (alternatively referred to as an electrochemical cell), according to aspects of the present disclosure. The battery cell 10 may be incorporated into a desired battery architecture, such as a stacked, winding, or cylindrical cell architectures. The battery cell 10 includes a separator 12 disposed between a pair of electrodes (anode 14 and cathode 16). The separator 12 is configured to electronically isolate the anode 14 and the cathode 16. The separator 12 may be a non-conductive, porous polymeric membrane. The anode 14 is disposed on a first current collector 18 and the cathode 16 is disposed on a second current collector 20, with each respective current collector being disposed opposite the separator 26.

The anode 14 is configured to intercalate ions while the battery cell 10 is charging and de-intercalate ions while the battery cell 10 is discharging. The anode 14 includes an electroactive material, such as a lithiated silicon material. In some aspects, the lithiated silicon material has a general formula of Li_{y}SiOₓ, where y is between 0 and 1 and x is between 0 and 2. In certain aspects, the lithiated material is a lithiated silicon-rich oxide, where x is less than 1. The lithiated silicon material may have a suitable morphology selected from the group consisting of nanoparticles, nanofibers, nanotubes, microparticles, combinations thereof, and the like.

The anode may further include a carbon material to enhance characteristics of the anode 14. For example, the carbon material may be selected to promote a particular morphology of the lithiated silicon material, enhance ion intercalation and deintercalation, optimize mechanical properties of the anode 14, combinations thereof, and the like. The carbon material may be selected from the group consisting of graphite, hard carbon, or soft carbon.

A suitable amount of lithiated silicon material is present in the anode 14. In some aspects, the lithiated silicon material is between 5 wt % and 80 wt % of the anode 14. In certain aspects, the lithiated silicon material is between 5 wt %-30 wt % of the anode 14. The anode 14 is loaded to provide optimize operating characteristics of the battery cell 10. In some aspects, the anode 14 is loaded to a capacity between 4 mAh/cm² and 8 mAh/cm². In certain aspects, the anode 14 is loaded to a capacity between 4.4 mAh/cm² and 5.5 mAh/cm².

The cathode 16 is configured to intercalate the ions received from the anode 14 when the battery cell 10 is discharging and de-intercalate the ions for transport to the anode 14 while the battery cell 10 is charging. The cathode 16 includes an electroactive material that is cooperative with the electroactive material of the anode 14 to facilitate ion flow and electron flow between the anode 14 and the cathode 16. The electroactive material of the cathode may be a transition-metal electroactive material, such as a nickel-rich material (e.g., >60% nickel). In some aspects, the nickel-rich material is selected from the group consisting of LiNiO₂ (LNO), Li[Ni_{1-x-y}CoₓMn_{y}]O₂ (NCM), Li[Ni_{1-x-y}CoₓAl_{y}]O₂ (NCA), Li[Ni_{1-x-y}CoₓMn_{y}Al_{z}]O₂ (NCMA), combinations thereof, and the like. In certain aspects, the nickel-rich material is selected from the group consisting of NCMA.

The first current collector 18 and the second current collector 20 are configured to collect and distribute free electrons from and to the adjacent anode 14 and cathode 16. The free electrons are moved between the first current collector 18 and the second current collector 20 via an external circuit 22. The external circuit 22 may include an external device 24 which may be a load that consumes electric power from the battery cell 10 and/or a power source that provides electric power to the battery cell 10.

Each of the anode 14, the cathode 16, and the separator 12 may further include an electrolyte 26. For example, pores of the anode 14, the cathode 16, and/or the separator 12 may be infilled with the electrolyte 26. The electrolyte 26 is formed from an electrolyte solution and promotes movement of ions between the anode 14 and the cathode 16 during charging and discharging of the electrochemical cell 10.

The electrolyte solution includes a primary salt, a secondary salt with a high highest occupied molecular orbital (a high-HOMO salt), and a solvent mixture including a fluorinated solvent. While not being bound by theory, it is believed that electrolyte solutions described herein optimize performance of the battery cell 10 by enhancing a solid-electrolyte interface (SEI) formed on the anode material, enhancing a cathode-electrolyte interface (CEI) formed on the cathode material, preferentially trapping generated oxygen radicals prior to their reaction with carbonate solvents, and inhibiting combustion and/or thermal runaway though gasification of the fluorinated solvent.

The primary salt is configured to configured to facilitate ion movement between the anode 14 and the cathode 16. The primary salt may be, for example, a lithium salt. In some aspects, the lithium salt may be selected from the group consisting of lithium hexafluorophosphate (LiPF₆); lithium difluorosulfimide (LiFSI); lithium bis(trifluoromethanesulfonyl)imide (LiTFSI); combinations thereof; and the like. In certain aspects, the primary salt is LiPF₆. The primary salt may be present in a concentration between 0.5M and 4M. In some aspects, the primary salt is present in a concentration between 0.5M and 1.2M. In certain aspects, the primary salt is present in a concentration of 0.5M.

The high-HOMO salt is selected to include an energy level of the HOMO that is sufficiently high to inhibit side reactions of the electrolyte solvents. These side reactions, such as the interaction between carbonate solvents and oxygen radicals, inhibit performance of the battery cell 10. For example, when a nickel-rich cathode is at charged state, structural collapse may occur if exposed to an elevated temperature (˜210° C.). The structural collapse generates oxygen radicals, which will intensely exothermically react with one or more carbonate components of the electrolyte 26. Beneficially, the high-HOMO salt acts to enhance the CEI formed by the electrolyte 26, to inhibit thermal runaway of the battery cell 10 by preferentially trapping oxygen radicals generated in the battery cell 10, which inhibits the occurrence of more vigorous and/or more exothermic reactions of the oxygen radicals with the carbonates in the electrolyte 26, and/or to enhance the SEI formed by the electrolyte 26.

In some aspects, the high-HOMO salt maybe selected from the group consisting of lithium difluoro(oxalato)borate (LiDFOB); lithium bis(oxalato)borate (LiBOB); lithium nitrite (LiNO₃); lithium difluorophosphate (LiDFP); lithium carbonate (Li₂CO₃); lithium fluoromalonato(difluoro)borate (LiFMDFB); lithium hexamethyldisilazide (LiHMDS); lithium tetrakis(pentafluorophenyl)borate (LiTPFPB); combinations thereof; and the like. In certain aspects, the high-HOMO salt is LiDFOB.

The high-HOMO salt may be present in a concentration that is less than or equal to the primary salt. In some aspects, the high-HOMO salt is present in a concentration between 0.05M and 0.5M. In certain aspects, the high-HOMO salt is present in a concentration between 0.1M and 0.5M. In certain further aspects, the high-HOMO salt is present in a concentration of 0.5M.

The solvent mixture includes a cyclic solvent component, a linear solvent component, and fluorinated solvent component. The solvent mixture is configured to maintain the primary salt and the secondary salt in a generally homogenous solution throughout the battery cell 10, to participate in formation of the SEI and CEI, and to provide a desired viscosity of the electrolyte 26 for a predetermined range of operating temperatures.

The cyclic solvent component is configured to participate in the formation of a stable SEI by promoting formation of lithium alkyl carbonates on the surface of the anode material. While not being bound by theory, it is believed that the cyclic solvent component or another cyclic solvent component may be configured to participate in the formation of a stable CEI on the surface of the cathode material.

The cyclic solvents may be selected from the group consisting of ethylene carbonate (EC); propylene carbonate (PC); γ-butyrolactone (γBL); 5-(3′,4′-dihydroxyphenyl)-γ-valerolactone (γVL); 4-methylmorpholine 4-oxide (NMO); combinations thereof; and the like. In some aspects, the cyclic solvent component is a combination of EC and PC. In some aspects, the cyclic solvent is present in an amount of between 10 wt % and 40 wt %. In certain aspects, the cyclic solvent is present in an amount of between 20 wt % and 30 wt %.

The linear solvent component is configured to optimize fluidity of the electrolyte 26 to optimize ion transport and operating temperature ranges for the battery cell 10. The linear solvent component may be a cyclic carbonate. In some aspects, the linear solvent component may be selected from the group consisting of dimethyl carbonate (DMC), ethyl methyl carbonate (EMC), diethyl carbonate (DEC), ethyl acetate (EA), n propyl acetate (nPA), i-propyl acetate (iPA), n-butyl acetate (nBA), i-butyl acetate (iBA), methyl propionate (MP), methyl butyrate (MB), methyl formate (MF), ethyl formate (EF), n-propyl formate (nPF), i-propyl formate (iPF), n-butyl formate (nBF), i-butyl formate (iBF), dimethyl formamide (DMF), dimethyl ketone (DMK), methyl ethyl ketone (MEK), acetonitrile (CAN), propionitrile (PN), n-butyronitrile (nBN), i-butyronitrile (iBN), combinations thereof, and the like. In certain aspects, the linear solvent component is selected from the group consisting of EMC, DMC, DEC, a combination thereof, and the like. In certain further aspects, the linear solvent component is DEC. The linear solvent may be present in an amount of between 60 wt % and 90 wt %. In some aspects, the linear solvent is present in an amount of between 70 wt % and 80 wt %.

The fluorinated solvent component is configured to inhibit side-reactions and consumption of the electrolyte 26. Additionally, or alternatively, the fluorinated solvent component may be configured to act as a flame retardant. The fluorinated solvent component may be or include one or more fluorinated cyclic carbonates, one or more fluorinated linear carbonates, a combination thereof, and the like. Beneficially, the fluorinated solvent components described herein are selected to act as a flame retardant during a thermal runaway event and to enhance formation of the SEI and CEI.

The fluorinated cyclic solvents may have the following general structure:

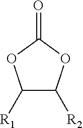

where the R₁ group, the R₂ group, or both include fluorine. Each of the R-groups may be or may include hydrogen, fluorine, a linear alkyl moiety, a branched alkyl moiety, a linear alkene moiety, a branched alkene moiety, a fluorinated alkyl moiety, a fluorinated alkene moiety, combinations thereof, and the like. The linear alkyl moiety and the branched alkyl moiety may have the generalized formula CₙH₂ₙ₊₁, where n is a value between 1 and 20. The linear alkene moiety and the branched alkene moiety may have the generalized formula CₙH₂ₙ, where n is a value between 1 and 20. The fluorinated alkyl moiety may have the generalized formula CₙH₂ₙ₊₁₋ₓFₓ, where n is a value between 1 and 20 and x is a value between 1 and 2n+1. The fluorinated alkene moiety may have the generalized formula CₙH₂ₙ₋ₓFₓ, where n is a value between 1 and 20 and x is a value between 1 and 2n.

The fluorinated cyclic solvent may be configured to enhance the SEI. In some aspects, the fluorinated cyclic solvent is selected from the group consisting of fluoroethylene carbonate (FEC); difluoroethylene carbonate (DFEC); trifluoropropylene carbonate (TFPC); 4-((2,2,3,3-tetrafluoropropoxy)methyl)-1,3-dioxolan-2-one (HFEEC); 4-(2,2,3,3,4,4,5,5,5-nonafluoropentyl)-1,3-dioxolan-2-one (NFPEC); combinations thereof; and the like. In certain aspects, the fluorinated cyclic solvent is FEC. The fluorinated cyclic solvent may be present in an amount between 2 wt % and 20 wt %. In some aspects, the fluorinated cyclic solvent may be present in an amount between 5 wt % and 15 wt %. In certain aspects, the fluorinated cyclic solvent is present in an amount of 15 wt %.

The fluorinated linear solvents may have the following general structure:

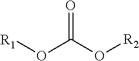

where the R₁ group, the R₂ group, or both include fluorine. Each of the R-groups may be or may include hydrogen, fluorine, a linear alkyl moiety, a branched alkyl moiety, a linear alkene moiety, a branched alkene moiety, a fluorinated alkyl moiety, a fluorinated alkene moiety, combinations thereof, and the like. The linear alkyl moiety and the branched alkyl moiety may have the generalized formula CₙH₂ₙ₊₁, where n is a value between 1 and 20. The linear alkene moiety and the branched alkene moiety may have the generalized formula CₙH₂ₙ, where n is a value between 1 and 20. The fluorinated alkyl moiety may have the generalized formula CₙH₂ₙ₊₁₋ₓFₓ, where n is a value between 1 and 20 and x is a value between 1 and 2n+1. The fluorinated alkene moiety may have the generalized formula CₙH₂ₙ₋ₓFₓ, where n is a value between 1 and 20 and x is a value between 1 and 2n.

The fluorinated linear solvent may be configured to enhance the CEI. In some aspects, the fluorinated linear solvent is selected from the group consisting of di-(2,2,2 trifluoroethyl) carbonate (DFDEC); methyl (2,2,2-trifluoroethyl) carbonate (FEMC); methyl-nonafluorobutyl ether (MFE); 1,1,1,3,3,3-hexafluoroisopropyl methyl ether (HFPM); 1,1,2,2-tetrafluoroethyl-2,2,3,3-tetrafluoropropyl ether (F-EPE); propargyl 2,2,2-trifluoroethyl carbonate; 2-cyanoethyl (2,2,2-trifluoroethyl) carbonate; 2,2,2-trifluoroethyl allyl carbonate; 3,5,8,10-oxa-4,9-carbonyl-1,1,1,12,12,12-hexafluoro-dodecane; 3,5,9,11-oxa-4,10-carbonyl-1,1,1,13,13,13-hexafluorotridecane; 3,5,10,12-oxa-4,11-carbonyl-1,1,1,14,14,14-hexafluorotetradecane; 3,5,10,12-oxa-4,11-carbonyl-1,1,1,14,14,14-hexafluoro-7-tetradecane; combinations thereof; and the like. In certain aspects, the fluorinated linear solvent is DFDEC. The fluorinated linear solvent may be present in an amount between 1 wt % and 70 wt %. In some aspects, the fluorinated linear solvent may be present in an amount between 10 wt % and 30 wt %. In certain aspects, the fluorinated linear solvent is present in an amount of 10 wt %.

The electrolyte solution may further include one or more additives. The additives may be configured to participate in passivating materials within the battery cell 10, participate in forming the SEI and/or CEI, and enhancing characteristics of the resultant SEI and/or CEI. The additives may include, for example, succinic anhydride (SA); vinylene carbonate (VC); trimethoxymethylsilane (TMSi); 1,3,2-dioxathiolane-2,2-dioxide (DTD); tris(trimethylsilyl) phosphite (TMSPi); combinations thereof; and the like. In some aspects, the additive is VC and is configured to enhance SEI formation on the graphitic anode by, for example, reducing a thickness of the SEI. The additives may be present in small or trace amounts sufficient to provide the desired effects. In some aspects, the additives are present in an amount less than 5 wt %. In some aspects, the additives are present in an amount between 0.5 wt % and 5 wt %. In certain aspects, the additives are present in an amount of 1 wt %.

The battery cell 10 may be formed by hot laminating the separator 12, the anode 14, and the cathode 16. In some aspects, the hot lamination process is carried out at a temperature between 65° C. and 85° C.

While aspects herein were described with reference to lithiated silicon oxides, it is contemplated that other silicon-based anode materials may be used. For example, the anode material may be Mg—Si, Si—C, SiOₓ.

As understood by one of skill in the art, the present disclosure is susceptible to various modifications and alternative forms, and some representative embodiments have been shown by way of example in the drawings and described in detail above. It should be understood, however, that the novel aspects of this disclosure are not limited to the particular forms illustrated in the appended drawings. Rather, the disclosure is to cover modifications, equivalents, combinations, sub-combinations, permutations, groupings, and alternatives falling within the scope and spirit of the disclosure and as defined by the appended claims.

As used herein, the phrase “may be selected from the group consisting of” as used in this section should be interpreted to mean “may include,” “may be selected from the group consisting of,” and “may be selected from the group consisting essentially of,” unless context dictates otherwise.

As used herein, the term “moiety” may also be used to refer to a functional group unless context dictates otherwise.

As used herein, unless the context clearly dictates otherwise: the words “and” and “or” shall be both conjunctive and disjunctive, unless the context clearly dictates otherwise; the word “all” means “any and all” the word “any” means “any and all”; the word “including” means “including without limitation”; and the singular forms “a”, “an”, and “the” includes the plural referents and vice versa.

Numerical values of parameters (e.g., of quantities or conditions) in this specification, unless otherwise indicated expressly or clearly in view of the context, including the appended claims, are to be understood as being modified by the term “about” whether or not “about” actually appears before the numerical value. The numerical parameters set forth herein and in the attached claims are approximations that may vary depending upon the desired properties sought to be obtained by the present disclosure. At the very least, and not as an attempt to limit the application of the doctrine of equivalents to the scope of the claims, each numerical parameter should at least be construed in view of the number of reported significant digits and by applying ordinary rounding techniques.

Words of approximation, such as “approximately,” “about,” “substantially,” and the like, may be used herein in the sense of “at, near, or nearly at,” “within 0-10% of,” or “within acceptable manufacturing tolerances,” or a logical combination thereof, for example.

While the metes and bounds of the term “about” are readily understood by one of ordinary skill in the art, the term “about” indicates that the stated numerical value or property allows imprecision. If the imprecision provided by “about” is not otherwise understood in the art with this ordinary meaning, then “about” indicates at least variations that may arise from ordinary methods of measuring and using such parameters. For example, if not otherwise understood in the art, the term “about” means within 10% (e.g., ±10%) of the stated value.

While the metes and bounds of the term “pure” are readily understood by one of ordinary skill in the art, the term “pure” indicates that the compound may include very slight traces of other materials. If the imprecision provided by “pure” is not otherwise understood in the art with this ordinary meaning, then “pure” indicates at least variations that may arise from separation processes and measurement of such parameters. For example, if not otherwise understood in the art, the term “pure” means above 99.9% of the stated material.

It is to be understood that the ranges provided herein include the stated range, subranges within the stated range, and each value within the stated range. For example, a range from 5 wt % to 80 wt % should be interpreted to include not only the explicitly recited limits of about 5 wt % to about 80 wt %, but also to include individual values, such as 5 wt %, 20 wt %, 40 wt %, 60 wt %, 80 wt %, etc., and sub-ranges, such as from about 5 wt % to about 40 wt %, 20 wt % to 60 wt %, etc.

While the best modes for carrying out the disclosure have been described in detail, those familiar with the art to which this disclosure relates will recognize various alternative designs and embodiments for practicing the disclosure within the scope of the appended claims.

### EXAMPLES

An electrolyte solution was produced using LiPF₆ as the primary salt and LiDFOB as the secondary salt. The amounts of LiPF₆ and LiDFOB were selected to produce a concentration of 0.5M LiPF₆ and 0.5M LiDFOB in the resulting electrolyte 26.

The LiPF₆ and LiDFOB were dissolved in a solvent solution that included the cyclic solvents EC and PC, the linear solvent DEC, and the fluorinated linear solvent DFDEC. The solvent solution had a ratio of 10 wt % EC, 20 wt % PC, 60 wt % DEC, and 10 wt % DFDEC.

FEC, a fluorinated cyclic solvent, was then added to the electrolyte mixture in an amount of 15 wt % of the resulting electrolyte 26. The additive VC was also added to the electrolyte mixture in an amount of 1 wt % of the resulting electrolyte 26. The electrolyte solution was then used to produce NCMA∥LSO-Graphite battery cells for testing. The LSO-Graphite anode was 40 wt % LSO and 60 wt % graphite.

Battery cells were also formed using a comparator electrolyte. The comparator electrolyte was prepared using 1M LiPF₆ in an EC/EMC solvent. The EC and EMC were present in a 3:7 volume ratio. The comparator electrolyte also included 2 wt % FEC and 1 wt % VC.

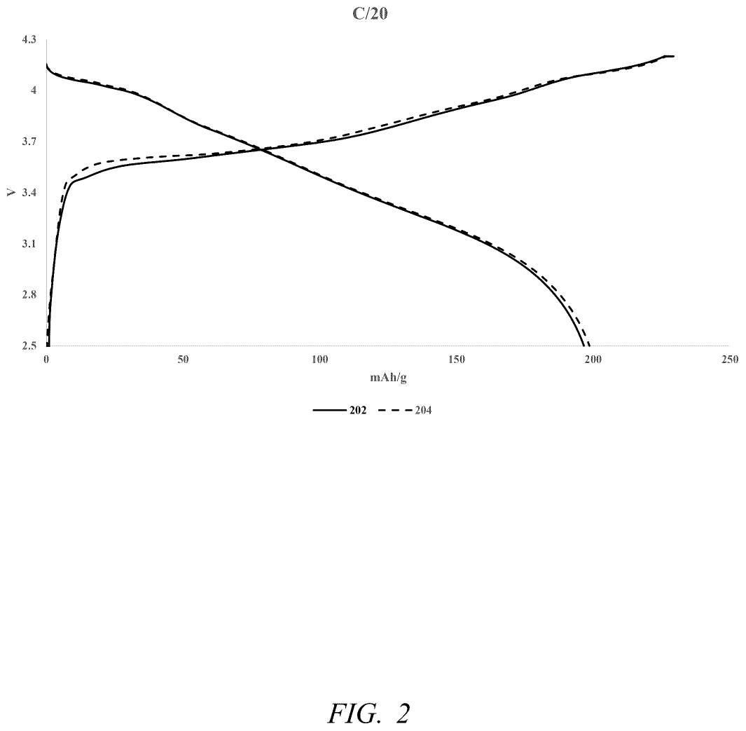

FIG. 2 illustrates a graph of specific capacity for the formation cycle of NCMA∥LSO-Graphite full coin cells. The cathode loading was 4 mAh cm², the N/P ratio was 1.1, and the C-rate was C/20. As can be seen in the figure, the example cell 202 and the comparator cell 204 provide comparable performance for constant current constant voltage (CCCV) charging and constant current (CC) discharging.

Three cells were tested for each electrolyte, and the example cells provided an initial coulombic efficiency and capacity that is comparable to the comparator cells. The specific charge capacity for the comparator cells was between 228.7 mAh/g and 232.5 mAh/g, with an average specific charge capacity of 230.3 mAh/g. The specific discharge capacity for the comparator cells was between 198.6 mAh/g and 202.3 mAh/g, with an average specific discharge capacity of 200.2 mAh/g. The coulombic efficiency for the comparator cells was between 86.8% and 87.0%, with an average coulombic efficiency of 86.9%.

The specific charge capacity for the example cells was between 224.1 mAh/g and 229.3 mAh/g, with an average specific charge capacity of 226.9 mAh/g. The specific discharge capacity for the example cells was between 191.3 mAh/g and 196.5 mAh/g, with an average specific discharge capacity of 194.2 mAh/g. The coulombic efficiency for the example cells was between 85.4% and 85.7%, with an average coulombic efficiency of 85.6%.

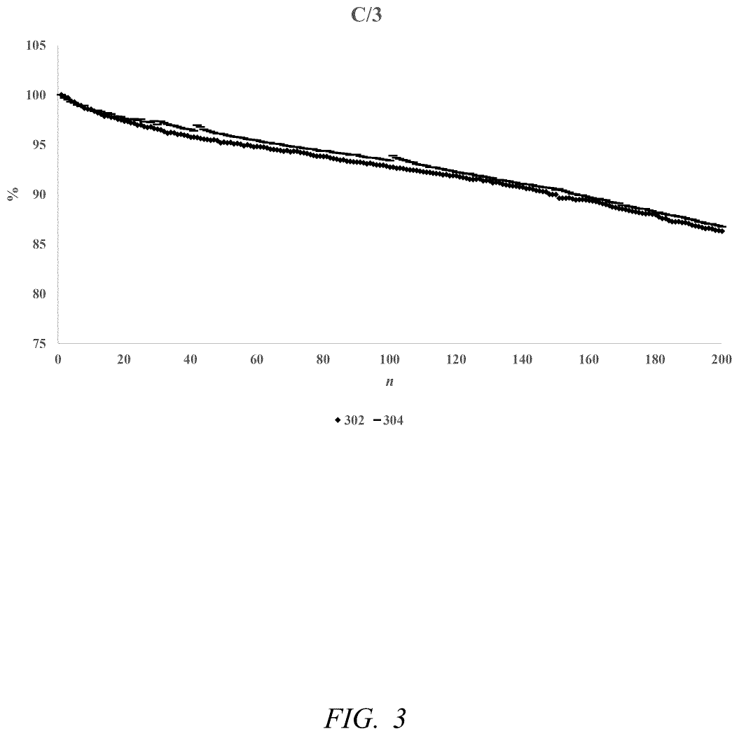

FIG. 3 is a chart of capacity retention over charge-discharge cycles for NCMA∥LSO-Graphite full coin cells. The cathode loading was 5 mAh cm², the N/P ratio was 1.1, and the C-rate for both charging and discharging was C/3. CCCV charging and CC discharging were used for each of the cycles. As can be seen, the coulombic efficiency of the example cells 302 are comparable to the coulombic efficiency of the comparator cell 304 across the tested number of cycles.

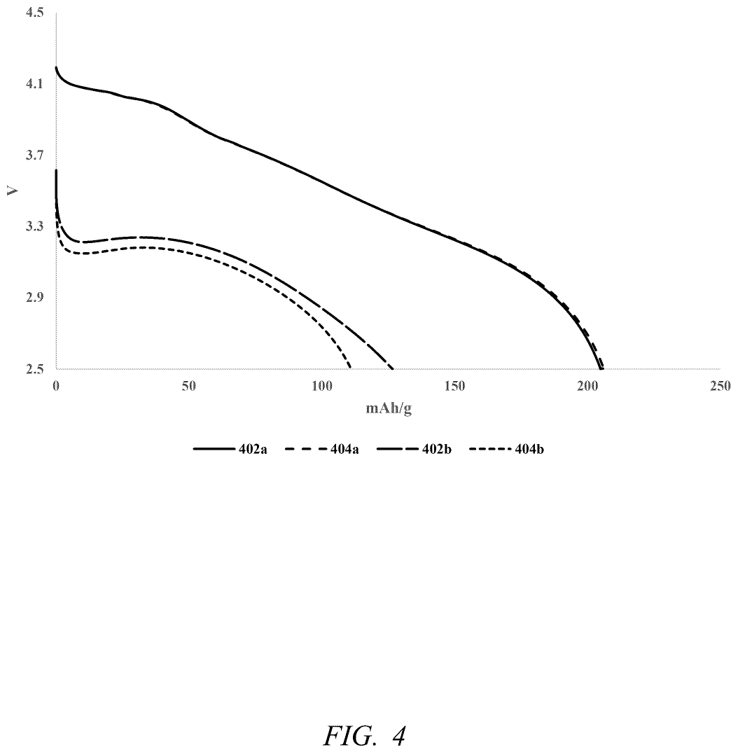

FIG. 4 is a chart showing the discharge voltage over specific capacity at different operating temperatures. Line 402a represents the example cell operating at 25° C., and line 404a represents the comparator cell operating at 25° C. Line 402b represents the example cell operating at −40° C., and line 404b represents the comparator cell operating at −40° C. As can be seen, the performance of the example cell and the comparator cell at 25° C. is nearly identical. Beneficially, as seen by lines 402b and 404b, the example cells provide enhanced performance over the comparator cells when the cells are operating at low temperatures. Specifically, the −40° C. operation of example cells exhibits a capacity retention of 62% from their operation at 25° C.

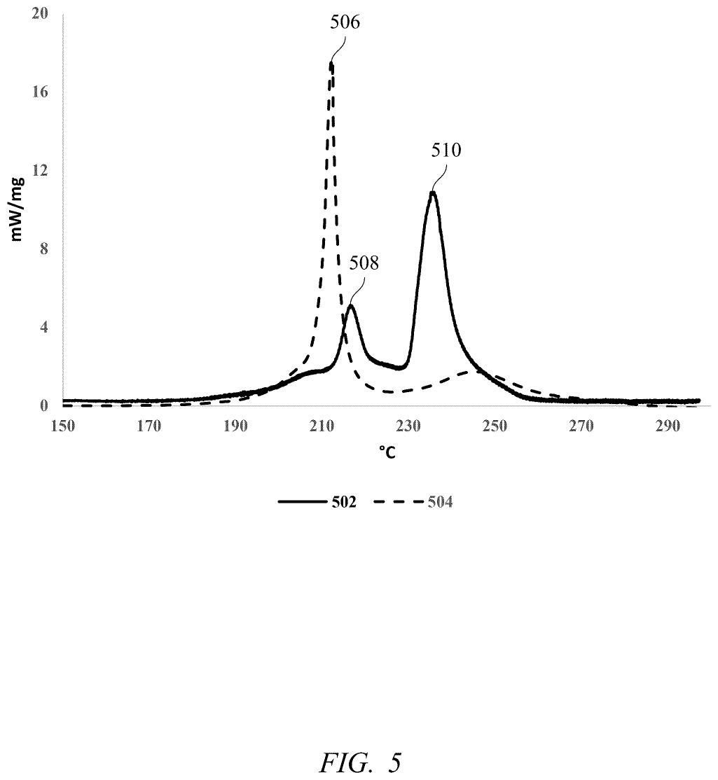

FIG. 5 is a chart showing differential scanning calorimetry (DSC) results for an NCMA cathode with the example electrolyte 502 and the comparator electrolyte 504. The DSC was performed at a scan rate of 5° C./min with a 100% state of charge for the cathode. The cathode had a diameter of 3 mm and a 0.4 mass ratio of electrolyte to cathode.

As can be seen, the comparator combination produces a strong peak 506 of at 212.5° C. This strong peak 506 reaches approximately 17 mW/mg and is brought on by the structural collapse of the NCMA at about 210° C.

When the cathode reaches about 210° C., the NCMA transitions from a R-3m layered phase to a Fd3m spinel phase, which leads to the production of free radical oxygen. The free radical oxygen then attacks components of the electrolyte, such as EC, to produce rapid exothermic reactions. The added heat flux cannot be adequately dissipated by the battery cell, so the cell temperature increases. While not being bound by theory, is believed that this accumulation of heat kicks off thermal runaway by promoting exothermic reactions of the LSO-Graphite (e.g., if the cell reaches 340° C.), which may produce a combustion reaction.

As can be further seen, peaks produced by the example combination have significantly reduced strength, are broader, and do not occur until higher temperatures relative to the comparator combination. More specifically, the first peak 508 and the second peak 510 of the example combination were reduced by about 70% and 35%, respectively, from the strength of peak 506. Further, the first peak 508 occurs at 214.6° C., about 2° C. above peak 506, and the second peak 510 occurs at 236.0° C., about 23.5° C. above peak 506.

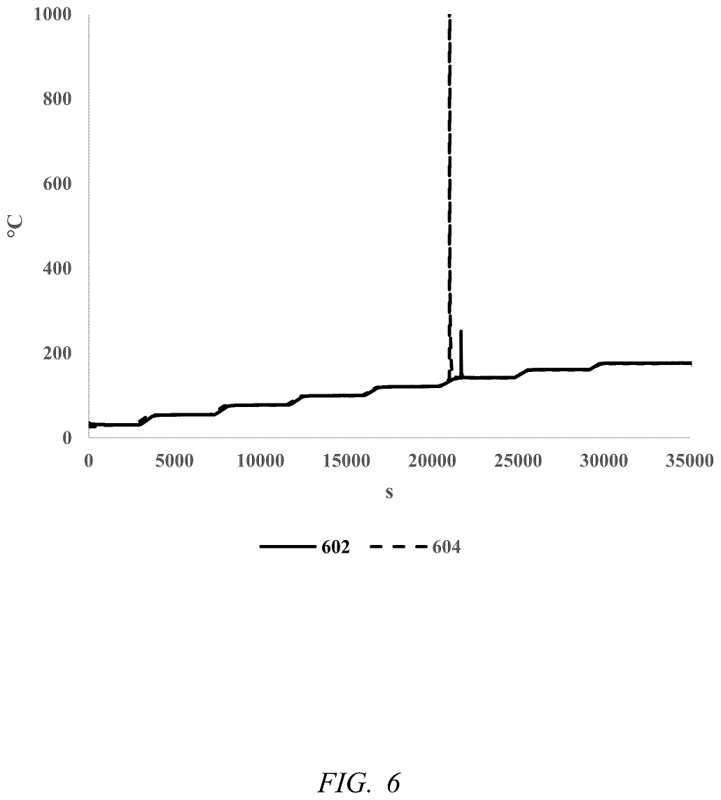

FIG. 6 is a chart showing a thermal ramping test for 3.7 Ah NCMA∥LSO-Graphite pouch cells. The test was performed using a stepwise heating-rest protocol with a heating rate of 2° C./min, a step of 25° C., and a rest until the difference between the cell temperature and the target temperature was less than 2° C. Each test was run for approximately 10 hours.

During the test, temperatures of the example cell 602 and the comparator cell 604 before and after occurrence of the thermal runaway were comparable. Yet, thermal runaway of the comparator cell 604 was initiated at a lower temperature and resulted in a much higher cell temperature than thermal runaway of the example cell 602. More specifically, the comparator cell 604 reached a peak temperature in excess of 1000° C. during the thermal runaway while the example cell 604 reached a peak temperature of only 251.8° C. during the thermal runaway.

The pouches were weighed both before and after the thermal ramping tests. Beneficially, the example cell 602 retained considerably more mass than the comparator pouch 604. More specifically, the mass of the example cell 602 went from 40.9 g to 19.4 g (˜47%) while the mass of the comparator cell 604 went from 41.1 g to 11.7 g (˜28%).

What is claimed is:

1. An electrochemical cell comprising:
an anode including a lithiated silicon oxide material;
a cathode including nickel-rich material; and
an electrolyte formed from an electrolyte mixture including:
a primary salt configured to facilitate ion movement between the anode and the cathode;
a secondary salt being a high-HOMO salt and being configured to form a solid-electrolyte interphase on the anode and a cathode-electrolyte interphase on the cathode; and
a solvent including a cyclic solvent component, a linear solvent component, and a fluorinated solvent component.

2. The electrochemical cell of claim 1, wherein the mixture further includes an additive configured to enhance a solid-electrolyte interface of the anode, the additive being selected from the group consisting of succinic anhydride; vinylene carbonate; tri-methoxymethylsilane; 1,3,2-dioxathiolane-2,2-dioxide; tris(trimethylsilyl) phosphite; and
combinations thereof.

3. The electrochemical cell of claim 1, wherein the high-HOMO salt is selected from the group consisting essentially of lithium difluoro(oxalato)borate (LiDFOB); lithium bis(oxalato)borate (LiBOB); lithium nitrite (LiNO₃); lithium difluorophosphate (LiDFP); lithium carbonate (Li₂CO₃); lithium fluoromalonato(difluoro)borate (LiFMDFB); lithium hexamethyldisilazide (LiHMDS); lithium tetrakis(pentafluorophenyl)borate (LiTPFPB); and combinations thereof.

4. The electrochemical cell of claim 3, wherein the high-HOMO salt is present in a concentration between 0.05M and 0.5M.

5. The electrochemical cell of claim 1, wherein the fluorinated solvent component is configured to inhibit side-reactions and consumption of the electrolyte and is selected from the group consisting of fluoroethylene carbonate (FEC); difluoroethylene carbonate (DFEC); trifluoropropylene carbonate (TFPC); 4-((2,2,3,3-tetrafluoropropoxy)methyl)-1,3-dioxolan-2-one (HFEEC); 4-(2,2,3,3,4,4,5,5,5-nonafluoropentyl)-1,3-dioxolan-2-one (NFPEC) di-(2,2,2 trifluoroethyl) carbonate (DFDEC); methyl (2,2,2-trifluoroethyl) carbonate (FEMC); methyl-nonafluorobutyl ether (MFE); 1,1,1,3,3,3-hexafluoroisopropyl methyl ether (HFPM); 1,1,2,2-tetrafluoroethyl-2,2,3,3-tetrafluoropropyl ether (F-EPE); propargyl 2,2,2-trifluoroethyl carbonate; 2-cyanoethyl (2,2,2-trifluoroethyl) carbonate; 2,2,2-trifluoroethyl allyl carbonate; 3,5,8,10-oxa-4,9-carbonyl-1,1,1,12,12,12-hexafluorododecane; 3,5,9,11-oxa-4,10-carbonyl-1,1,1,13,13,13-hexafluorotridecane; 3,5,10,12-oxa-4,11-carbonyl-1,1,1,14,14,14-hexafluorotetradecane; 3,5,10,12-oxa-4,11-carbonyl-1,1,1,14,14,14-hexafluoro-7-tetradecane; and combinations thereof.

6. The electrochemical cell of claim 1, wherein:
the cyclic solvent component includes fluorine and has the following structure: 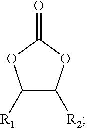
the linear solvent component includes fluorine and has the following structure: 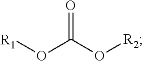
and
each of the R-groups is selected from the group consisting of hydrogen, fluorine, a linear alkyl moiety, a branched alkyl moiety, a linear alkene moiety, a branched alkene moiety, a fluorinated alkyl moiety, and a fluorinated alkene moiety.

7. The electrochemical cell of claim 1, wherein the primary salt is LiPF₆ present in a concentration of 0.5M, the secondary salt is LiDFOB present in a concentration of 0.5M, the cyclic solvent component is a combination of ethylene carbonate (EC) and propylene carbonate (PC), the linear solvent component is DEC, and the fluorinated solvent component is a combination of FEC and DFDEC.

8. The electrochemical cell of claim 7, wherein the FEC is present in an amount of 15 wt % on a basis of the electrolyte.

9. The electrochemical cell of claim 8, further comprising vinylene carbonate (VC) in an amount of 1 wt % on a basis of the electrolyte.

10. The electrochemical cell of claim 1, wherein the electrochemical cell is formed by hot laminating the anode, the cathode, and a separator using a temperature between 65° C. and 85° C.

11. An electrolyte comprising:
a primary salt configured to facilitate ion movement between an anode and a cathode;
a secondary salt being a high-HOMO salt and being configured to form a solid-electrolyte interphase on the anode and a cathode-electrolyte interphase on the cathode; and
a solvent including a cyclic solvent component, a linear solvent component, and a fluorinated solvent component.

12. The electrolyte of claim 11, wherein the electrolyte further includes an additive configured to enhance a solid-electrolyte interface of the anode, the additive being selected from the group consisting of succinic anhydride; vinylene carbonate; tri-methoxymethylsilane; 1,3,2-dioxathiolane-2,2-dioxide; tris(trimethylsilyl) phosphite; and combinations thereof.

13. The electrolyte of claim 11, wherein the high-HOMO salt is selected from the group consisting essentially of lithium difluoro(oxalato)borate (LiDFOB); lithium bis(oxalato)borate (LiBOB); lithium nitrite (LiNO₃); lithium difluorophosphate (LiDFP); lithium carbonate (Li₂CO₃); lithium fluoromalonato(difluoro)borate (LiFMDFB); lithium hexamethyldisilazide (LiHMDS); lithium tetrakis(pentafluorophenyl)borate (LiTPFPB); and combinations thereof.

14. The electrolyte of claim 13, wherein the high-HOMO salt is present in a concentration between 0.05M and 0.5M.

15. The electrolyte of claim 11, wherein the fluorinated solvent component is configured to inhibit side-reactions and consumption of the electrolyte and is selected from the group consisting of fluoroethylene carbonate (FEC); difluoroethylene carbonate (DFEC); trifluoropropylene carbonate (TFPC); 4-((2,2,3,3-tetrafluoropropoxy)methyl)-1,3-dioxolan-2-one (HFEEC); 4-(2,2,3,3,4,4,5,5,5-nonafluoropentyl)-1,3-dioxolan-2-one (NFPEC) di (2,2,2 trifluoroethyl) carbonate (DFDEC); methyl (2,2,2 trifluoroethyl) carbonate (FEMC); methyl nonafluorobutyl ether (MFE); 1,1,1,3,3,3 hexafluoroisopropyl methyl ether (HFPM); 1,1,2,2 tetrafluoroethyl 2,2,3,3 tetrafluoropropyl ether (F EPE); propargyl 2,2,2 trifluoroethyl carbonate; 2 cyanoethyl (2,2,2 trifluoroethyl) carbonate; 2,2,2 trifluoroethyl allyl carbonate; 3,5,8,10 oxa 4,9 carbonyl 1,1,1,12,12,12 hexafluoro-dodecane; 3,5,9,11 oxa 4,10 carbonyl 1,1,1,13,13,13 hexafluorotridecane; 3,5,10,12 oxa 4,11 carbonyl 1,1,1,14,14,14 hexafluorotetradecane; 3,5,10,12 oxa 4,11 carbonyl 1,1,1,14,14,14 hexafluoro 7 tetradecane; and combinations thereof.

16. The electrolyte of claim 11, wherein:
the cyclic solvent component includes fluorine and has the following structure: 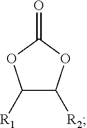
the linear solvent component includes fluorine and has the following structure: 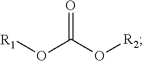
and
each of the R-groups is selected from the group consisting of hydrogen, fluorine, a linear alkyl moiety, a branched alkyl moiety, a linear alkene moiety, a branched alkene moiety, a fluorinated alkyl moiety, and a fluorinated alkene moiety.

17. The electrolyte of claim 11, wherein the primary salt is LiPF6 present in a concentration of 0.5M, the secondary salt is LiDFOB present in a concentration of 0.5M, the cyclic solvent component is a combination of ethylene carbonate (EC) and propylene carbonate (PC), the linear solvent component is DEC, and the fluorinated solvent component is a combination of FEC and DFDEC.

18. The electrolyte of claim 17, wherein the FEC is present in an amount of 15 wt % on a basis of the electrolyte.

19. The electrolyte of claim 18, further comprising vinylene carbonate (VC) in an amount of 1 wt % on a basis of the electrolyte.

20. The electrolyte of claim 11, wherein the electrolyte is configured to be incorporated into an electrochemical cell formed by hot laminating the anode, the cathode, and a separator using a temperature between 65° C. and 85° C.
